(19) United States
(12) Patent Application Publication
(10) Pub. No.: US 2016/0125320 A1
(43) Pub. Date: May 5, 2016

(54) GROUPING FLIGHT SEARCH RESULTS

(71) Applicant: Google Inc., Mountain View, CA (US)

(72) Inventors: Ralf Metzger, Zurich (CH); Jiri Semecky, Adliswil (CH); Peter Werner Balsiger, Bern (CH); Piotr Maciej Buczek, Zurich (CH); Ally Gale, Zurich (CH); Lukas Platinsky, Levice (SK)

(21) Appl. No.: 14/530,573

(22) Filed: Oct. 31, 2014

(51) Int. Cl. G06Q 10/02

(52) U.S. Cl. CPC G06Q 10/02

(57) ABSTRACT

Methods, systems, and apparatus, including computer programs encoded on a computer storage medium, for information retrieval. In one aspect, a method includes receiving a flight search query, the flight search query identifying a plurality of flight parameters including a departure location, a destination location, and at least one date; obtaining a plurality of flight search results that satisfy the flight search query; grouping the plurality of flight search results into groups based at least in part on calculated similarity between flight search results of the plurality of flight search results, wherein the similarity is based on a combination of a plurality of features of the respective flight itineraries of the flight search results; and providing the plurality of flight search results for display in a flight search results interface including providing at least one group result of the generated groups of flight search results.

### BACKGROUND

This specification relates to information retrieval.

Conventional online travel booking sites allow users to identify and purchase travel according to a specified itinerary. For example, a user may use a flight search tool to view flight itineraries that match flight search parameters such as origin location, destination location, and travel dates. The user can select and purchase a flight itinerary that best matches the user's preferences. Typically, following the purchase of a particular flight itinerary, the user will follow the flight itinerary and complete the trip.

### SUMMARY

This specification describes technologies relating to grouping flight search results.

In general, one innovative aspect of the subject matter described in this specification can be embodied in methods that include the actions of receiving a flight search query, the flight search query identifying multiple flight parameters including a departure location, a destination location, and at least one date; obtaining multiple flight search results that satisfy the flight search query; grouping the multiple flight search results into groups based at least in part on calculated similarity between flight search results of the multiple flight search results, wherein the similarity is based on a combination of multiple features of the respective flight itineraries of the flight search results; and providing the multiple flight search results for display in a flight search results interface including providing at least one group result of the generated groups of flight search results. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The multiple features include price, duration, and number of stops. The multiple features further include particular airline carriers and airports. The method further includes calculating a quality score for each flight search result and group result and determining one or more best flight itineraries in response to a corresponding quality score that satisfies a threshold value. The one or more best flight itineraries are provided for presentation as a top flight search result in the flight search results interface. Each group includes flight itineraries having a price that is within a specified range of prices for flights in the group. Providing the at least one group result includes determining that the number of generated groups satisfies a threshold value. The threshold number of generated groups is at least two groups of flight search results. At least one group includes flights search results for more than one airline.

In general, one innovative aspect of the subject matter described in this specification can be embodied in methods that include the actions of providing a flight search interface configured to receive a flight search query; receiving a flight search query through the provided flight search interface, the flight search query identifying multiple flight parameters including a departure location, a destination location, and at least one date; obtaining flight search results including one or more groups of flight search results, the flight search results grouped according to one or more criteria; and providing a flight results interface configured to present the obtained flight search results, wherein presenting the flight search results includes providing a list of flight search results sorted by price, wherein the list of flight search results includes one or more group result, wherein each group result includes a timeline display of flight search results in the group, and wherein the display is further configured, in response to received input to a particular group result, to expand the particular group of flight search results to display each individual flight search result. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. The timeline display of flight search results in a particular group is further configured to display an indicator for each flight in the group along the timeline. The timeline display of flight search results in a particular group is further configured to display, in response to a user interaction with a particular indicator, the particular times and price associated with the corresponding flight search result. A price range is displayed with each group result, the price range corresponding to the range of prices for flight search results of the group. Each group result includes flight search results for two or more distinct airlines.

Particular embodiments of the subject matter described in this specification can be implemented so as to realize one or more of the following advantages. Grouping flight search results allows a user to more easily identify similar flights as well as available flights at a particular price point. Condensing flight search results of a group to a single row in a search results interface significantly reduces the number of total result rows in the search results interface, which allows users to more quickly scan the available flight search results. Users can expand grouped flight search results to easily view the individual flight options of the group. Even when flight results are grouped, the flights can remain ordered by price in the listing of results presented in the search results interface. Grouped flights can provide a more intuitive user experience that is analogous to other forms of transit, e.g., bus schedules showing busses leaving every 15 minutes. Users can readily see that there are similar flights throughout a day to a particular destination and at a similar price, which can help alleviate fears of missing a flight since there are other flights that can be taken. Users can easily see which airlines fly and the frequency of flights for a particular destination.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example flight search interface including grouped flight search results.

FIG. 2 is an example system for providing flight search results.

FIG. 3 is a flow diagram of an example process for providing grouped flight search results.

FIG. 4 is an example flight search interface.

FIG. 5 is another example flight search interface.

FIG. 6 is another example flight search interface.

Like reference numbers and designations in the various drawings indicate like elements.

### DETAILED DESCRIPTION

A travel search system can identify flight search results that are responsive to a flight search query. The system can determine whether to provide flight results grouped into one or more groups for display on a user device. The flight search results can be provided to a requesting device such that a flights results interface includes a list of flight search results including one or more group results. Each group result can include a timeline having respective indicators for each flight in the group along the timeline. The provided flight results interface can be configured to expand the group in response to a received input as well as to display details of individual flights in response to a received input to a particular indicator on the timeline.

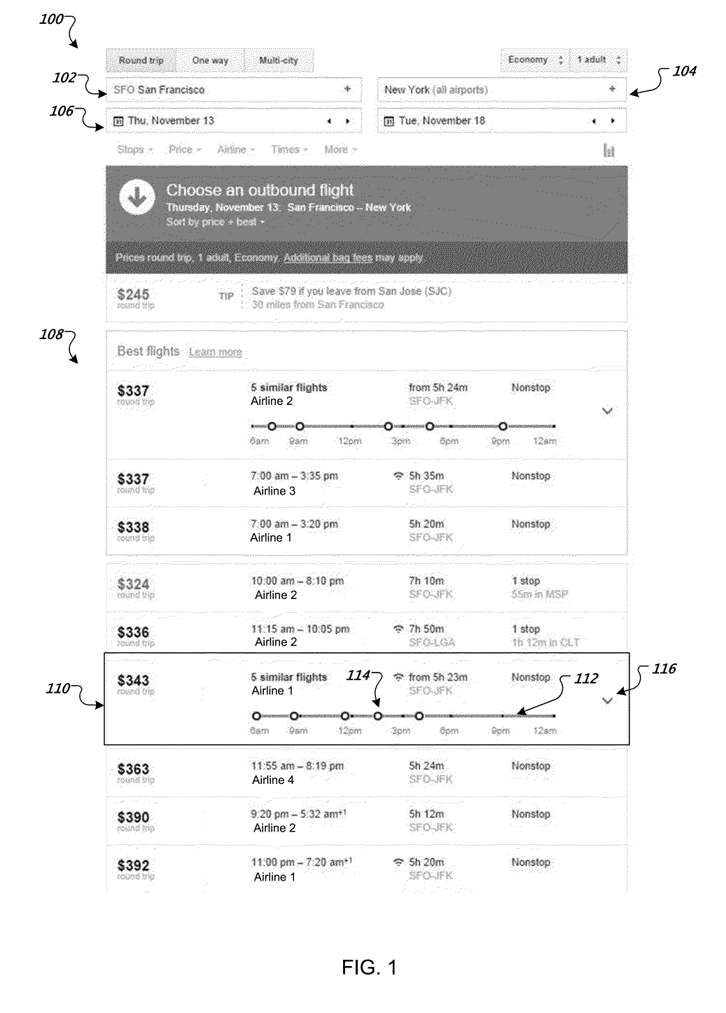

FIG. 1 is an example flight search interface 100 including grouped flight search results. The flight search interface 100 can be presented on a display of a suitable user device including, for example, a mobile phone, tablet, computer, etc. In particular the flights search interface 100 includes indicating flight parameters used for the flight search including a departure location 102, a destination location 104, and at least one date 106. The departure location 102 indicates the origin location for a flight and the destination location indicates a destination for the flight.

The departure location 102 can be a particular airport, for example, identified by name or by airport code, e.g., “SFO” for San Francisco International Airport. The departure location 102 can also indicate a city or metropolitan area that includes one or more airports within a specified arrange. For example, a departure location of “San Francisco” can include San Francisco International Airport, Oakland International Airport, and San Jose International Airport. Similarly, the destination location 104 can represent a particular airport or city/metropolitan area, in this example, “JFK” airport in New York.

The at least one date 106 indicates a departure date for the flight. If the flights search is for one-way flight itineraries, only the departure date is provided. For round-trip flights, a return date is also included.

A listing of flight search results 108 shows a number of individual and group flight search results including group result 110. The group result 110 provides a single result row that represents multiple individual flight itineraries from the departure location to the destination location. Specifically, the group result 110 shows five similar flights having a same price of $343 dollars round-trip. The individual flight itineraries are illustrated on a timeline 112 by indicators 114. Each indicator is positioned on the timeline relative to the respective departure time of each flight itinerary. Other flight information includes the type of flight, e.g., non-stop, 1 stop, 2 stop, etc., the minimum duration (in this example 5 hours 23 minutes) and the particular carrier (in this example Airline 1). In some implementations, the group can include flight itineraries from multiple airlines. The group result 110 also includes an expansion control 116. The expansion control, in response to a received input, expands the entry in the listing of flight search results 108 to display information for each individual flight itinerary in the group, as described in greater detail below.

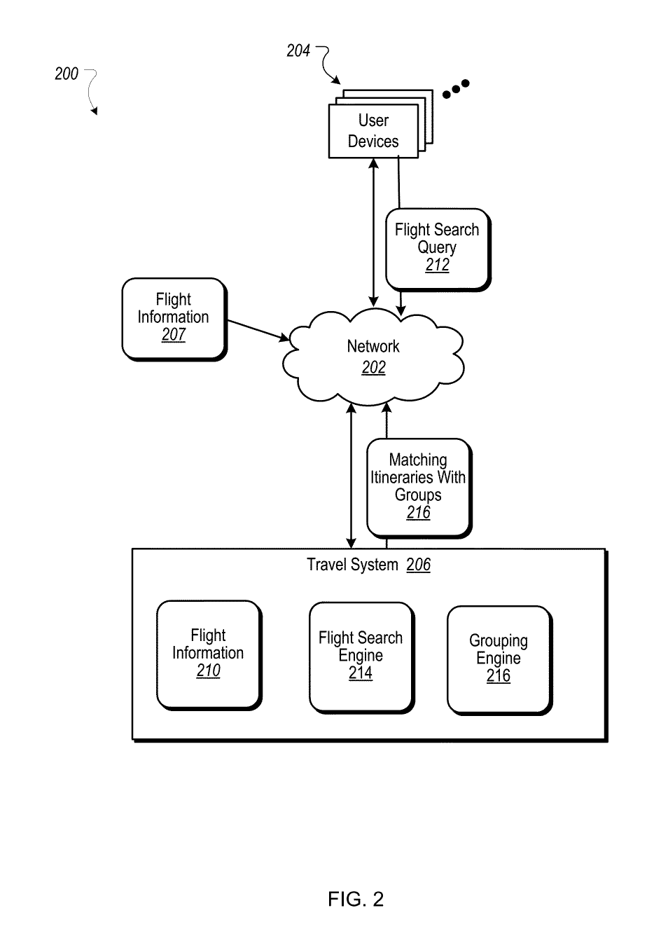

FIG. 2 is an example system 200 for providing flight search results. The system 200 includes a network 202, such as a local area network (LAN), a wide area network (WAN), the Internet, or a combination thereof. The network 202 connects user devices 204 to a travel system 206. The system 200 may include many user devices 204, which can each be associated with one or more users.

The user device 204 is an electronic device that is under control of a user and is capable of requesting and receiving resources over the network 202. Example user devices 204 include personal computers, tablet computers, mobile communication devices (e.g., smartphones), televisions, set top boxes, personal digital assistants and other suitable devices that can send and receive data over the network 202. A user device 204 typically includes one or more user applications, such as a web browser, to facilitate the sending and receiving of data over the network 202. A user of a user device 204 can, for example, use a web browser to search for a particular travel itinerary, including a flight itinerary.

The travel system 206 can receive a flight search query 212 from a user device 204. The flight search query 212 can include one or more parameters, such as values for departure location, destination location, and one or more travel dates. In some implementations, the flight search query 212 is input to a flight search interface that includes respective fields for inputting parameter values. In some other implementations, the flight search query 212 is a free text query to a search field that includes values for the one or more parameters. The departure and destination locations can identify cities or particular airports.

The travel system 206 can use a flight search engine 214 to determine flight search results responsive to the received flight search query 212. In particular, the flight search engine 214 can apply the received flight search query 212 to flight information 210. Flight information 210 includes flight information received from a cache of flight information that is periodically updated or directly obtained from flight information 207 outside of the travel system 206, which can include, for example, flight information received from individual carriers, or flight information received as aggregated from carriers by another system.

The flight information 210 includes a collection of flight legs identifying flights and the details from each flight including, for example, the particular departure location, destination location, date and time of departure, duration, carrier, flight number, etc. In some implementations, the details further include pricing and seat availability information for each flight leg. A flight itinerary can be constructed from one or more legs. The flight information can also include rules for assembling two or more flight legs to form a flight itinerary having one or more connections, e.g., pricing rules, partner carrier rules, etc.

The flight search engine 214 can query the flight information 210 based on the received search parameters to generate a collection of matching flight itineraries that are responsive to the received flight search query 212. The matching itineraries can include, for example, hundreds (or more) of flight itineraries depending on the particular route and other flight parameters. In some implementations, the received flight search query includes additional parameters corresponding to different flight preferences, e.g., time of travel, number of connections that are acceptable, class of service. These additional parameters can be used to further limit the flight search results, or can be used to filter a broader set of flight search results such that the parameters can be later modified without performing the search again.

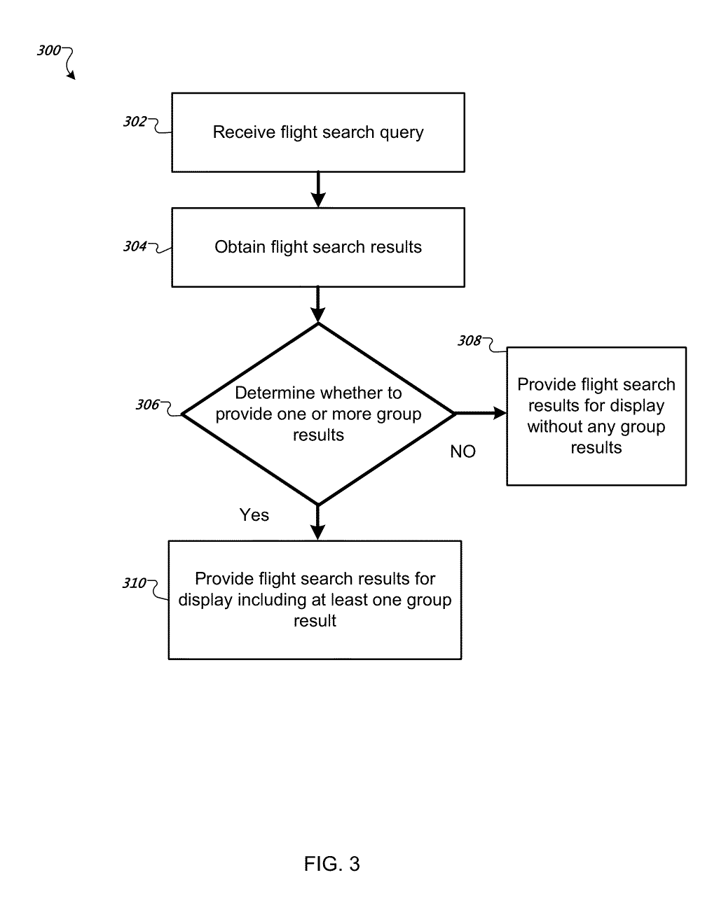

The travel system 206 also includes a grouping engine 216. The grouping engine 216 determines whether to provide one or more group results based on a number of groups of itineraries generated from the collection of matching flight itineraries. Criteria for determining to provide groups of flight itineraries and techniques for grouping individual flight itineraries are described in greater detail below with respect to FIG. 3. A group of flight search results can represent flight itineraries responsive to the received flight search query that have similar features.

The matching flight itineraries 216, which can include one or more groups of flight itineraries, that satisfy the flight search query 212 can be provided to the user device 204, for presentation on a display of the user device 204 as flight search results. For example, the itineraries 216 can be presented in an itinerary list in a travel search results interface. If the matching flight itineraries 216 include one or more groups, each group can be presented as a group result in a list of flight search results. Each group result can include a timeline that shows the respective flight itineraries of the group e.g., with respect to departure time. The displayed list of flight itineraries can be configured to provide additional information about the respective flight itineraries in response to an input, e.g., from a user of the user device 204. For example, the additional information can include booking information for purchasing the particular flight itinerary including one or more links to respective third party booking providers.

FIG. 3 is a flow diagram of an example process 300 for providing grouped flight search results. For convenience, the process 300 will be described as being performed by a system of one or more computers, located in one or more locations, and programmed appropriately in accordance with this specification. For example, a travel search system, e.g., the travel search system 206 of FIG. 2, appropriately programmed, can perform the process 300.

The system receives a flight search query (302). The travel system can receive the flight search query from a user device, e.g., user device 204, displaying a search interface. The flight search query can include values for one or more parameters, such as values for departure location, destination location, and one or more travel dates. For example, the received flight search query can include parameter values indicating a departure location, for example, San Francisco, a destination location, e.g., New York City, and one or more specific travel dates, e.g., one way travel departing on March 15^{th} or round-trip travel November 13-22. In some implementations, additional travel parameters can be received as part of the search query. For example, the search interface can include fields or selection elements for additional parameters including, for example, time of travel (e.g., morning or afternoon), number of connections that are acceptable (e.g., nonstop, one stop, two stops), class of service (e.g., first, business, economy), etc.

The system obtains flight search results responsive to the received flight search query (304). The system can use obtained flight information as described above to identify a collection of matching flight itineraries that are responsive to the received flight search query. In some other implementations, the system sends the query to another search system that returns responsive flight itineraries.

The system determines whether to provide one or more group results generated from the collection of flight itineraries (306). The system analyzes features of the collection of flight itineraries to determine whether to provide one or more group results.

In particular, the system can calculate a similarity score for flight itineraries of the collection of flight itineraries. For example, a similarity score can be calculated using values assigned for particular features of the flight itineraries. The features used can include price, duration, and number of stops. Each flight itinerary can be scored based on a combination of these features. The features can optionally be weighted to provide more weight in the similarity score calculation to particular features, e.g., price, relative to other features in the similarity score calculation.

If the scores of the flight itineraries are within a specified range, the itineraries can be grouped as similar flight itineraries. In some implementations, additional features can be used in determining similarity include the airline, for example, different feature values for common airlines, partner airlines, and airlines with no relationship. Another feature can include departure and/or arrival airports. Specifically, there may be more than one airport servicing the departure or destination locations. The particular airport in the collection of itineraries can be a feature used to group flight itineraries.

In some implementations, the itineraries are grouped as similar flight itineraries based on a k-means clustering which clusters the flight itineraries into k clusters based on the values for the particular features of the flight itineraries. The clusters group similar flight itineraries based on the selected features. Alternatively, other suitable clustering techniques can be used.

In some alternative implementations, each of the specified features are individually compared to the corresponding feature of other flight search results. For example, the prices can be compared, the duration can be compared, and the number of stops can be compared individually. If the comparison yields a similarity within a threshold amount, e.g., a particular percentage of price, a particular length of time, or a particular number of stops, the flight results are similar with respect to that feature. If the specified features satisfy this similarity, the corresponding flight itineraries are grouped together.

In some implementations, the grouping process can be constrained to groups having a single airline and/or a same price. In some implementations, the flight itineraries of the collection of flight itineraries are individually sorted by price to identify flight itineraries of the collection of flight itineraries that have the same or similar pricing. For example, the flight itineraries can be sorted into specified buckets having particular price ranges. For example, flight itineraries can be initially grouped by flight itineraries having a same price, or flight itineraries that can be clustered within buckets having a specified price range widths of a specified amount, e.g., by 10 percent or 15 percent price width. These initial price clusters can be further analyzed and scored according to other features to determine similar itineraries as described above.

In some implementations, the flight itineraries of the collection of flight itineraries are also analyzed to identify one or more “best” flight itineraries responsive to the query. Determining the best flight itineraries, whether represented as individual or as a generated group, can be based on a quality score that takes into account a number of features of the flight itineraries, for example, price, flight duration, and number of stops. The features can be weighted to give more influence to the score for particular features. In some cases, the highest scoring flight itineraries, which may be a group of flight itineraries, are identified as “best” flight itineraries.

In some implementations, the best flight itineraries are a specified number of highest scoring flight itineraries. In some other implementations, the best flight itineraries are limited to those that satisfy a threshold score value. Alternatively, the best flight itineraries can be combination of a fixed number of highest scoring itineraries that also satisfy the threshold score value. In some implementations, the highest scoring flight itineraries according to the quality score can also be grouped together. In some of these scenarios, the highest scoring flight itineraries are only grouped if they also satisfy the similarity measure described above.

The “best” flight itineraries can identify suitable flights that provide a trade off between price and convenience. These flights may also correspond to those most likely to be selected by users, e.g., based on historical information. This trade off can take into account additional factors beyond price, flight duration, and number of stops, including, for example, departure/arrival time of day, particular airlines, or types of connections required. The particular trade off formula used can depend on the particular market, e.g., short vs. long distance or domestic vs. international flight, or can depend on the user, e.g., business vs. leisure traveler.

The system can determine whether a number of generated groups satisfy a threshold number. For example, a threshold can be selected such that there are a minimum number of groups needed to display group results, for example 2 or 3 groups. If a single group is generated, this may not satisfy the threshold value and the flight itineraries of the group will be provided as individual flight search results.

In response to a determination that one or more group results are not to be provided, the system provides flight search results for display without including any group results (308). For example, if no groups or generated or the number of groups generated are less than the threshold value, no groups are provided.

In response to a determination that one or more group results are to be provided, the system provides flight search results for display including at least one group result (310). For example, if the number of groups generated exceeds the threshold value, group results are provided. The flight search results can be provided as a list of flight search results sorted according to particular criteria, for example, price. The at least one group result can be included in the list at a location based on the sorting. For example, if the group result represents a group of flight itineraries having a particular price, and the results are listed in order by price, the group result is included in the listing based on the price order.

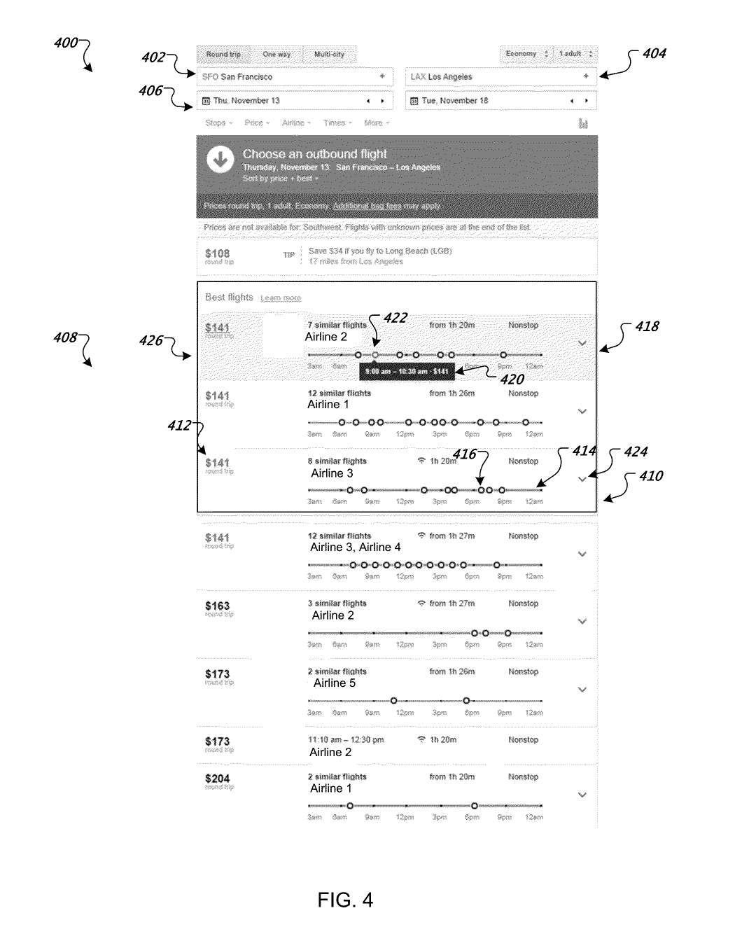

FIG. 4 is an example flight search interface 400. The flight search interface 400 can be presented on a display of a suitable user device, for example, user device 204 of FIG. 2. In particular the flight search interface 400 includes flight parameters used for the flight search including a departure location 402, a destination location 404, and at least one date 405. In this example, the departure location 402 is San Francisco and the destination location 404 is Los Angeles.

In the flight search interface 400, a list of flight search results 408 is presented for matching flight itineraries that satisfy the flight parameters submitted in a flight search query. The flight search results 408 are presented as a list of flight search results sorted according to particular criteria, in this example, by price from lowest to highest.

In particular, in this example, all but one of the displayed flight search results listed are group results. Each group result represents two or more flight itineraries that were grouped as described above with respect to FIG. 3. Each group result includes a timeline having indicators representing each flight itinerary of the group. For example, group result 410 includes a price 412 for flight itineraries of the group, $141 dollars, as well as other common information including carrier name and minimum flight duration time (1 hour 20 minutes).

The group result 410 also includes a timeline 414 that includes indicator 416. Each indicator 416 is positioned relative to a time on the timeline that corresponds to the departure time of a particular flight itinerary. For example, as showing by group result 410, the group includes 8 similar flight itineraries that have been grouped together. Two of the flight itineraries are indicated as departing between 6 am and 9 am; one of the flight itineraries is indicated as departing between 12 pm and 3 pm; two of the flight itineraries are indicated as departing between 3 pm and 6 pm; and three of the flight itineraries are indicated as departing between 6 pm and 9 pm.

A user can interact with the group results to more specifically view details of a particular flight itinerary. For example, group result 418 includes hover text 420 generated in response to a user interaction with a particular indicator 422. In particular, in response to the user interaction the hover text 420 indicates the specific departure and arrival times and price for that flight itinerary associated with the indicator 422. In some other implementations, the specific flight itinerary information is provided in response to a user selection of the corresponding indicator.

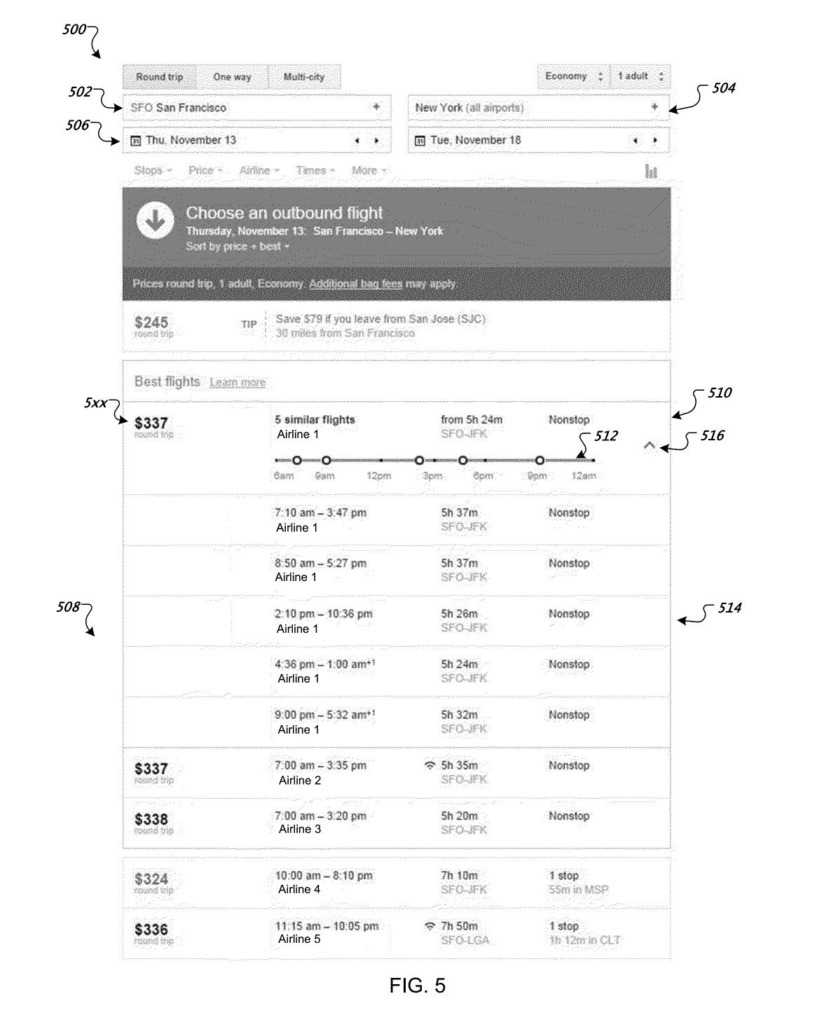

The group results each include an expansion element, for example expansion element 424 of group result 410. The expansion element 424 is configured, in response to a received input, for example from a user of the user device, to expand the group result 410 to display the flight itineraries that are members of the group result 410. An example of the expanded search result listing is described below with respect to FIG. 5.

In some implementations, individual flight search results, or one or more group results, can be designated as representing the “best” flight itineraries responsive to the flight search query. As shown in FIG. 4, group results 426 are identified as “best flights.” Determining the best flight itineraries, whether represented as individual or group results, can be based on a scoring process that takes into account a number of features of the flight itineraries, for example, price, flight duration, and number of stops. The features can be weighted to give more influence to the score for particular features. In some cases, the highest scoring flight itineraries, which may be a group of flight itineraries, are identified as “best” flight itineraries. In some implementations, the best flight itineraries are a specified number of highest scoring flight itineraries. In some other implementations, the best flight itineraries are limited to those that satisfy a threshold score value. Alternatively, the best flight itineraries can be combination of a fixed number of highest scoring itineraries that also satisfy the threshold score value.

FIG. 5 is an example flight search interface 500. The flight search interface 500 can be presented on a display of a suitable user device, for example, user device 204 of FIG. 2. In particular the flights search interface 500 includes flight parameters used for the flights search including a departure location 502, a destination location 504, and at least one date 505. In this example, the departure location 502 is San Francisco and the destination location 504 is Los Angeles.

In the flights search interface 500, a list of flights search results 508 is presented for matching flight itineraries that satisfy the flight parameters submitted in a flights search query. The flight search results 508 are presented as a list of flight search results sorted according to particular criteria, in this example, by ascending price.

The flight search results 508 include a group result 510 that has been expanded to display the individual flight itineraries 514 that are members of the group. The group result 510 still shows the group result including a timeline 512 having indicators for each of the five flight itineraries in the group. The group result 510 is expanded, for example, based on an input selecting an expansion element such as expansion element 424 of FIG. 4. In place of the expansion element, a contraction element 516 is shown. The listing of flight search results 508 can be configured to contract the group result 510 in response to an input to the contraction element 516 such that the group result 510 is displayed without the individual member flight itineraries.

The individual flight itineraries 514 identify the specific details of each flight itinerary including departure and arrival times, carrier, duration, route, and number of stops. Although in this example all of the individual flight itineraries 514 are on the same carrier, a group can include flight itineraries from multiple different carriers. As shown in the example, each of the individual flight itineraries 514 have similar but not identical duration. Additionally, in this example all flight itineraries have the same price as indicated in the group result 510. However, in some implementations, the prices of individual flight itineraries in the group can have prices within a specified range. In those cases, the individual prices can be shown for each flight itinerary.

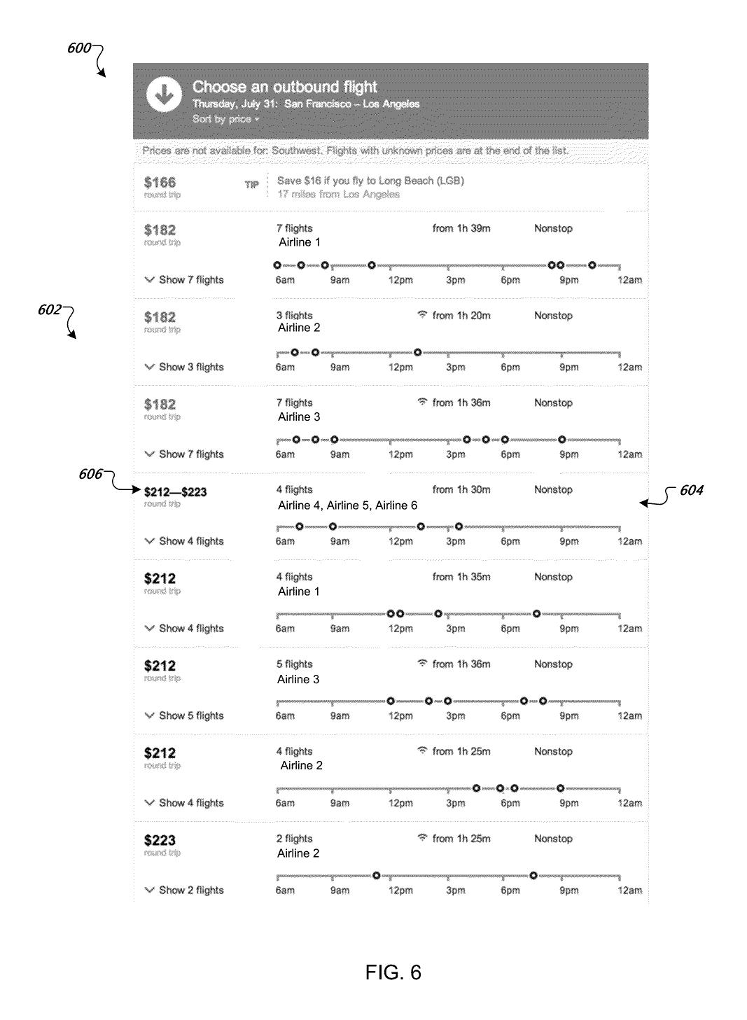

FIG. 6 is an example flights search interface 600. The flight search interface 600 can be presented on a display of a suitable user device, for example, user device 204 of FIG. 2. In particular the flights search interface 600 simply displays a portion including a listing of flight search results 602 for flight itineraries departing on July 31 from San Francisco to Los Angeles.

The flight search results 602 include a number of group results. In particular, the flight search results 602, in this example, include group result 604. Group result 604 indicates that there are four flight itineraries in the group and that they are on three different airlines, airline 4, airline 5, and airline 6. Additionally, the group result 604 includes a price 606 that indicates a range of prices for the flight itineraries in the group. The range of prices for the group can be based on criteria in generating the groups, for example, that prices of flight itineraries of a group need to be within a specified range. For example, the prices of flight itineraries of a group may need to be within 10 percent of an average price for flights in the group. This allows more flexibility in generating groups of similar flight search results.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a flight search query, the flight search query identifying a plurality of flight parameters including a departure location, a destination location, and at least one date;
obtaining a plurality of flight search results that satisfy the flight search query;
grouping the plurality of flight search results into groups based at least in part on calculated similarity between flight search results of the plurality of flight search results, wherein the similarity is based on a combination of a plurality of features of the respective flight itineraries of the flight search results; and
providing the plurality of flight search results for display in a flight search results interface including providing at least one group result of the generated groups of flight search results.

2. The method of claim 1, wherein the plurality of features include price, duration, and number of stops.

3. The method of claim 2, wherein in the plurality of features further include particular airline carriers and airports.

4. The method of claim 1, further comprising calculating a quality score for each flight search result and group result and determining one or more best flight itineraries in response to a corresponding quality score that satisfies a threshold value.

5. The method of claim 4, wherein the one or more best flight itineraries are provided for presentation as a top flight search result in the flight search results interface.

6. The method of claim 1, wherein each group includes flight itineraries having a price that is within a specified range of prices for flights in the group.

7. The method of claim 1, wherein providing the at least one group result includes determining that the number of generated groups satisfies a threshold value.

8. The method of claim 1, wherein the threshold number of generated groups is at least two groups of flight search results.

9. The method of claim 1, wherein at least one group includes flights search results for more than one airline.

10. A method comprising:
providing a flight search interface configured to receive a flight search query;
receiving a flight search query through the provided flight search interface, the flight search query identifying a plurality of flight parameters including a departure location, a destination location, and at least one date;
obtaining flight search results including one or more groups of flight search results, the flight search results grouped according to one or more criteria; and
providing a flight results interface configured to present the obtained flight search results, wherein presenting the flight search results includes providing a list of flight search results sorted by price, wherein the list of flight search results includes one or more group result, wherein each group result includes a timeline display of flight search results in the group, and wherein the display is further configured, in response to received input to a particular group result, to expand the particular group of flight search results to display each individual flight search result.

11. The method of claim 10, wherein the timeline display of flight search results in a particular group is further configured to display an indicator for each flight in the group along the timeline.

12. The method of claim 11, wherein the timeline display of flight search results in a particular group is further configured to display, in response to a user interaction with a particular indicator, the particular times and price associated with the corresponding flight search result.

13. The method of claim 11, wherein a price range is displayed with each group result, the price range corresponding to the range of prices for flight search results of the group.

14. The method of claim 10, wherein each group result includes flight search results for two or more distinct airlines.

15. A system comprising:
one or more computers and one or more storage devices storing instructions that are operable, when executed by the one or more computers, to cause the one or more computers to perform operations comprising:
receiving a flight search query, the flight search query identifying a plurality of flight parameters including a departure location, a destination location, and at least one date;
obtaining a plurality of flight search results that satisfy the flight search query;
grouping the plurality of flight search results into groups based at least in part on calculated similarity between flight search results of the plurality of flight search results, wherein the similarity is based on a combination of a plurality of features of the respective flight itineraries of the flight search results; and
providing the plurality of flight search results for display in a flight search results interface including providing at least one group result of the generated groups of flight search results.

16. A system comprising:
one or more computers and one or more storage devices storing instructions that are operable, when executed by the one or more computers, to cause the one or more computers to perform operations comprising:
providing a flight search interface configured to receive a flight search query;
receiving a flight search query through the provided flight search interface, the flight search query identifying a plurality of flight parameters including a departure location, a destination location, and at least one date;
obtaining flight search results including one or more groups of flight search results, the flight search results grouped according to one or more criteria; and
providing a flight results interface configured to present the obtained flight search results, wherein presenting the flight search results includes providing a list of flight search results sorted by price, wherein the list of flight search results includes one or more group identifiers, wherein each group identifier includes a timeline display of flight search results in the group, and wherein the display is further configured, in response to received input to a particular group identifier, to expand the particular group of flight search results to display each individual flight search result.

17. One or more computer-readable storage media encoded with instructions that, when executed by one or more computers, cause the one or more computers to perform operations comprising:
receiving a flight search query, the flight search query identifying a plurality of flight parameters including a departure location, a destination location, and at least one date;
obtaining a plurality of flight search results that satisfy the flight search query;
grouping the plurality of flight search results into groups based at least in part on calculated similarity between flight search results of the plurality of flight search results, wherein the similarity is based on a combination of a plurality of features of the respective flight itineraries of the flight search results; and
providing the plurality of flight search results for display in a flight search results interface including providing at least one group result of the generated groups of flight search results.

18. One or more computer-readable storage media encoded with instructions that, when executed by one or more computers, cause the one or more computers to perform operations comprising:
providing a flight search interface configured to receive a flight search query;
receiving a flight search query through the provided flight search interface, the flight search query identifying a plurality of flight parameters including a departure location, a destination location, and at least one date;
obtaining flight search results including one or more groups of flight search results, the flight search results grouped according to one or more criteria; and
providing a flight results interface configured to present the obtained flight search results, wherein presenting the flight search results includes providing a list of flight search results sorted by price, wherein the list of flight search results includes one or more group identifiers, wherein each group identifier includes a timeline display of flight search results in the group, and wherein the display is further configured, in response to received input to a particular group identifier, to expand the particular group of flight search results to display each individual flight search result.
